(19) United States
(12) Patent Application Publication
(10) Pub. No.: US 2007/0252686 A1
(43) Pub. Date: Nov. 1, 2007

(54) Vehicle Braking Warning Apparatus

(76) Inventors: Stewart Grant Andrews, Howick (NZ); David John Barrowman, Waimauku (NZ); Damon Partington, Henderson (NZ)

Correspondence Address: YOUNG & THOMPSON, 745 SOUTH 23RD STREET, 2ND FLOOR, ARLINGTON, VA, 22202, US

(21) Appl. No.: 11/596,475

(22) PCT Filed: May 11, 2005
(86) PCT No.: PCT/NZ05/00094

§ 371 Date: Apr. 13, 2007

(30) Foreign Application Priority Data
May 11, 2004 (NZ) 532868

(51) Int. Cl. B60Q 1/44

(52) U.S. Cl. 340/479

(57) ABSTRACT

An electrically operated vehicle deceleration device for providing a warning to other motorists of the deceleration of a vehicle. The device is typically coupled into the existing electrical lighting system to operate at least the rear hazard/indicator lights. The device includes a terminal block which provides for the vehicle's battery to power the device via a regulated power supply. The terminal block connects the device to all the hazard/indicator lights of a vehicle via a deceleration sensor which in turn is coupled to triggering elements such as a programmable interrogation/activation microprocessor, which is programmed to provide triggering at two different thresholds of deceleration as detected by the sensor. A first threshold is provided when deceleration approaches 0.8 g-force and a second threshold when deceleration approaches 0.9 g-force. At the threshold levels the microprocessor signals a power output stage which provides for illumination, in different pre-selected modes, of the hazard/indictor lights.

### TECHNICAL FIELD

This invention relates to vehicle deceleration including braking warning device. More particularly the invention relates to an electrically operated device that can be coupled into the lighting circuitry of a vehicle to activate at least some of the vehicles lights, preferably at least the rear hazard/indicator lights, upon the rate of deceleration of the vehicle reaching a predetermined threshold. Thus the activation will provide a visual deceleration warning illumination to other motorists particularly any following motorists. Typically activation will result from deceleration caused by the application of the vehicles brakes and thus will be in addition to the braking light warning conventionally provided.

### BACKGROUND ART

With conventional vehicle brake light warning illuminations the “braking” warning illumination is the same regardless of the extent of deceleration of a vehicle. An intention of this invention is to provide a device that will monitor and signal the deceleration rate of a vehicle. It is envisaged this will assist other motorists particularly following motorists and thereby be beneficial to road safety. It is an object of this invention to provide such a device that may either be incorporated into new vehicles or retro-fitted to existing vehicles. Preferably the device will utilise and be readily connectable into a vehicles existing lighting circuitry, in particular that part of the circuitry connected to the vehicles indicator/hazard lights.

Hereinafter, the invention is described in conjunction with a vehicles hazard/indicator lights. This comes about because current road safety regulations in some countries prohibit use of a vehicle braking and/or tail lights for purposes other than their intended/regulated use. However, from the following description it will be apparent to those skilled in the art that the device could equally as well be operated in conjunction with other external lights of a vehicle. Further, it will be apparent the device could be operated with all of a vehicles conventional external lights and/or additional lights. This selection of hazard/indicator lights within the description should thus not be construed as a limitation of the scope of the invention.

### DISCLOSURE OF INVENTION

According to a first embodiment of this invention there is provided an electrical operated vehicle deceleration warning device broadly comprising a deceleration sensor coupled into the circuitry of at least a vehicles rear hazard/indicator lights, the circuitry including triggering means, activated by the change in the forces of momentum acting upon and detected by the deceleration sensor, caused by deceleration changes in the vehicles speed, activation occurring at a first deceleration threshold predetermined and set within the device and resulting in the device sending a signal to at least one of the rear hazard/indicator lights of the vehicle to cause the light(s) to illuminate, for a first predetermined period.

According to a second embodiment of this invention there is provided an electrical operated vehicle deceleration warning device as described in the preceding paragraph wherein the triggering means provides for a second activation to occur at a second and higher rate of deceleration threshold than that of the first threshold, the device providing that the consequential illumination mode of the hazard/indicator light(s) at the second threshold is for a second predetermined period and differs from the illumination mode provided at the first threshold.

According to a third embodiment of this invention there is provided an electrical operated vehicle deceleration warning device as described in either of the two immediately preceding paragraphs wherein the mode of illumination at the first threshold is substantially the same as the conventional illumination mode of the hazard/indicator lights.

According to a fourth embodiment of this invention there is provided an electrical operated vehicle deceleration warning device as described in any one of the three immediately preceding paragraphs wherein sensor is gravitationally sensitive and calibration means are included in the device, enabling the sensor to be zeroed when mounted in situ.

According to a fifth embodiment of this invention there is provided an electrical operated vehicle deceleration warning device as described in any one of the four immediately preceding paragraphs wherein should the second activation occur during the first illumination period the illumination period thereafter will be the second illumination period.

According to a sixth embodiment of this invention there is provided an electrical operated vehicle deceleration warning device as described in either of the preceding paragraphs wherein the second threshold activation causes the hazard/indicator lights to flash at a rate noticeably higher than their conventional flashing rate.

According to a seventh embodiment of this invention there is provided an electrical operated vehicle deceleration warning device as described in any one of the six immediately preceding paragraphs incorporated into a vehicle.

### BRIEF DESCRIPTION OF DRAWINGS

FIGS. 1 is a simplified circuit diagram of a preferred embodiment of the device suitable for retro-fitting to the lighting circuitry of an existing vehicle, and

FIGS. 2-5 are detailed views of the blocks A-D depicted on FIG. 1.

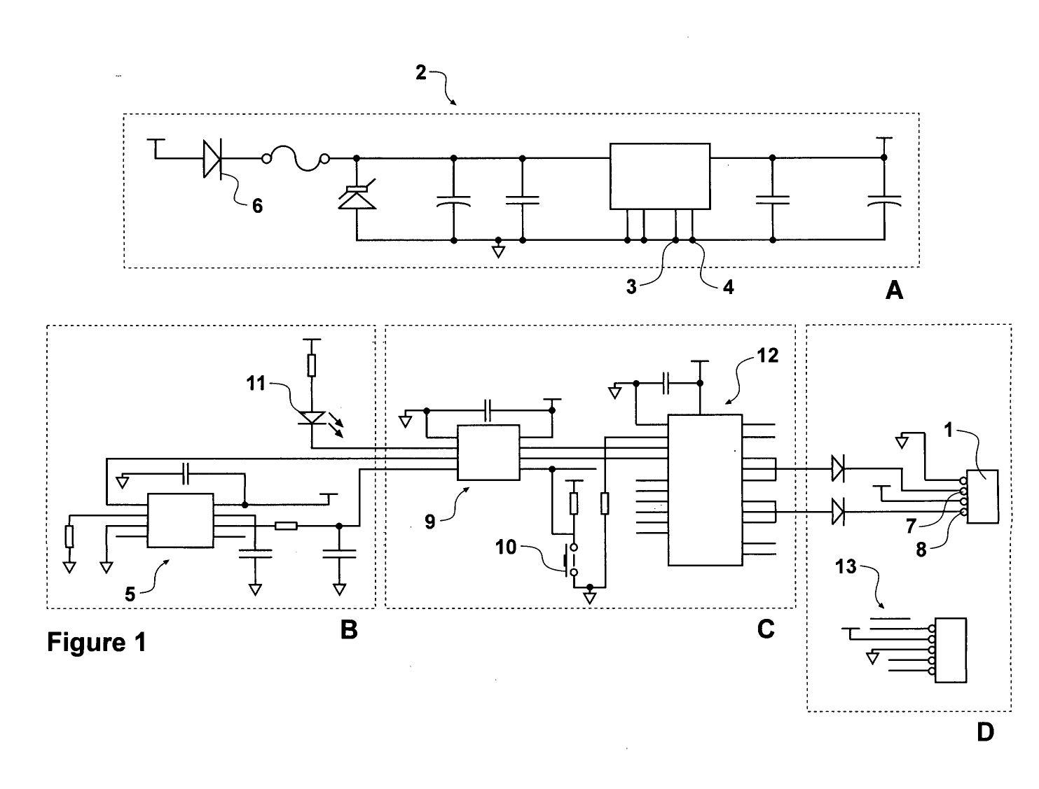

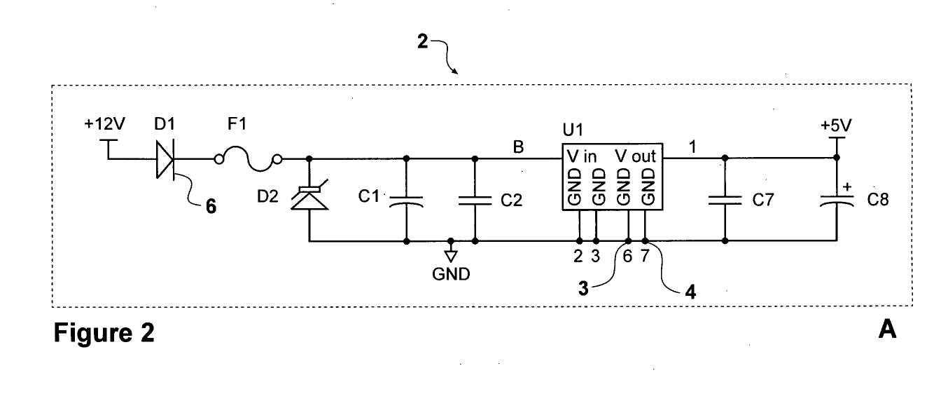

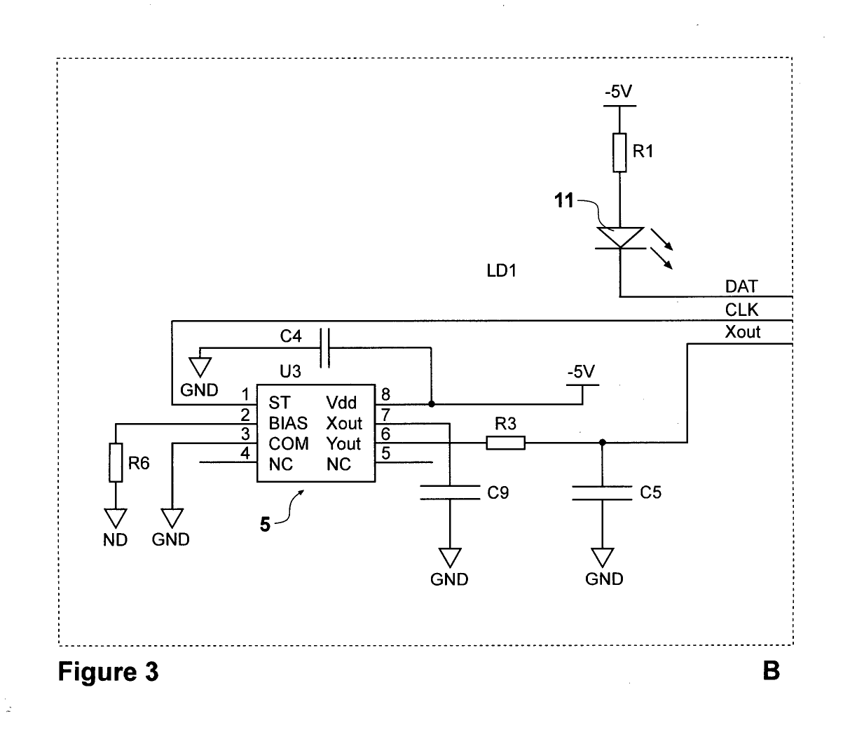

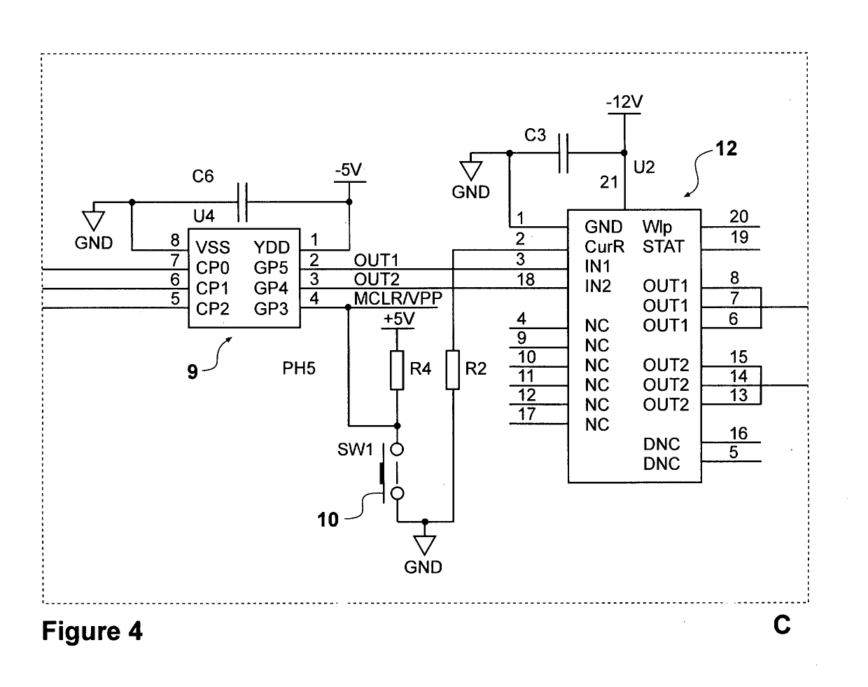

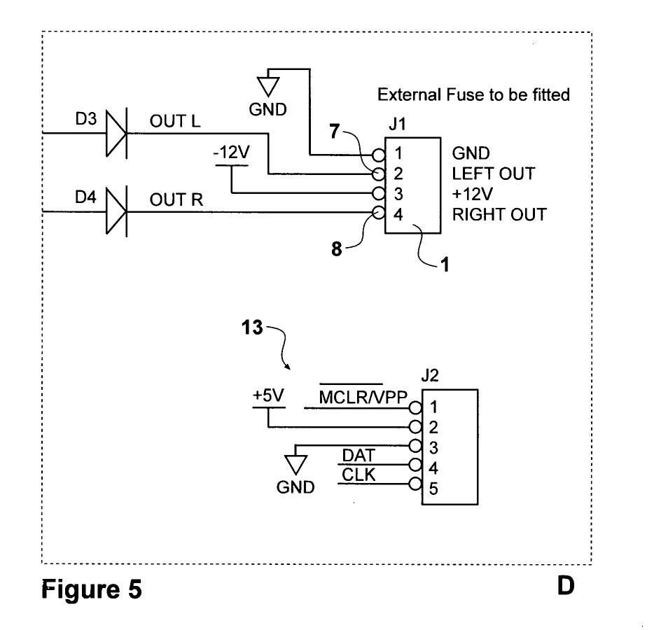

### BEST MODE FOR CARRYING OUT THE INVENTION

Preferably the device is adapted to be powered by a vehicles battery and connected into the existing lighting circuitry of a vehicle. To that end the device preferably includes a multi-contact terminal block 1 including a terminal 12V for connection to a vehicles battery to provide a power source, typically of 12 volts to the device. Preferably the power is fed to the device via a voltage stabilising, filtering and protection stage 2 (depicted as a separate circuit for clarity) which also includes a voltage step-down stage (to 5v at terminals 3,4) to supply a sensor 5 described in more detail below. Preferably the power supply 2 also includes a diode 6 to eliminate feed-back from a vehicles electrical circuit, in particular a vehicles hazard/indicator lights (as mentioned above, the preferred illumination means operated by the device) to which the device is connected via terminals 7, 8 on block 1. It will be appreciated the power supply 1 can readily be adapted to be fed from a 24 volt source such as often provided on larger vehicles.

It is envisaged that most benefit form the device will be achieved by providing a warning signal at a rear of a vehicle and connection of the device could be so limited to rearwardly directed lights of a vehicle. However, normally it is found that installation is more convenient if it includes those hazard/indicator lights at a front and/or side as well as a rear of a vehicle. Also, if anything it is envisaged this will enhance rather than detract from the warning provided by the device. As described in more detail below, the device causes the hazard/indicator lights to illuminate to provide a warning particularly to following motorists of a vehicles deceleration.

The device includes a sensor 5 device to detect the change in the forces of momentum acting thereon arising from deceleration of a vehicle in which it is mounted. A preferred sensor 5 is a polysilicon, surface-micromachined structure built on top of a silicon wafer. It is sensitive to gravitational forces acting thereon, with polysilicon springs suspending the structure over the surface of the wafer to provide a resistance against acceleration/deceleration forces. Such a sensor is marketed as an ICS ADXL311JE. The sensor 5 is coupled to triggering means such a programmable interrogation/activation microprocessor device 9 which monitors and acts upon the output of the sensor 5. Preferably the interrogation/activation device 9 is programmed to provide triggering at two different thresholds of deceleration as detected by the sensor 5. More particularly, preferably a first threshold is provided when deceleration approaches 0.8 g-force. Preferably a second threshold is provided when deceleration approaches 0.9 g-force.

As the sensor 5 is sensitive to gravitational forces in situ the device, in particular the sensor 5 needs to be “zeroed” or calibrated once mounted. To that end a biased off push-switch 10 and a LED 11 are preferably provided. Activating the switch 10 for an initial period of about 2 seconds checks the device is correctly connected to the hazard/indicator lights, LED 11 correspondingly flashes. Continued activation of switch 10 for about 5 seconds calibrates the sensor 5 by instructing the interrogation/activation microprocessor 9 that this state of the sensor 5 is “zero”, the LED 11 providing a confirming flash. It will be appreciated that the sensor 5 will also detect acceleration of a vehicle and the interrogation/activation microprocessor 9 is programmed to ignore this.

Preferably activation of the device takes place at two different deceleration threshold levels noted by the sensor 5 and the interrogation/activation microprocessor 9. Preferably the interrogation/activation microprocessor 9 signals a power output stage 12. In the preferred embodiment the output stage 12 provides for illumination, in a pre-selected mode, of a vehicles hazard/indictor lights. Preferably the illumination mode at the first threshold is the same or substantially the same as that conventionally provided by a vehicles hazard/indicator lights. Typically this is a flashing illumination at a frequency of about 2-2.5 Hz. Preferably the illumination mode provided at the second threshold is noticeably different from the conventional illumination mode of the indicator lights. Preferably the illumination mode at the second threshold is flashing illumination at a frequency of approximately 5 Hz.

Thus it will be seen that the device will “automatically” provide deceleration warning signals separate from any braking warning that may be provided. Further, typically deceleration will be as a consequence of the braking of the vehicle and the warning signals provided by the device will often be in association with conventional “braking” warning signals. “Braking” warning signals are normally provided by a constant red light activated by a vehicles braking mechanism and thus the warning illumination(s) provided by the device will also be readily distinctive therefrom.

The period(s) of the illumination is controlled by the interrogation/activation processor 10. Preferably the illumination period provided for the first threshold activation is about 3-4 seconds and that for the second threshold illumination 5-6 seconds. Preferably the programming of the interrogation/activation microprocessor 9 provides that should the second threshold activation be reached during the first illumination period then the second illumination period will be enabled and thereafter will control the remaining period of illumination. A programming block 13 (depicted separately for clarity) is preferably included in the device.

1. An electrical operated vehicle deceleration warning device broadly comprising a deceleration sensor coupled into the circuitry of at least a vehicles rear hazard/indicator lights, the circuitry including triggering means, activated by the change in the forces of momentum acting upon and detected by the deceleration sensor, caused by deceleration changes in the vehicles speed, activation occurring at a first deceleration threshold predetermined and set within the device and resulting in the device sending a signal to at least one of the rear hazard/indicator lights of the vehicle to cause the light(s) to illuminate, for a first predetermined period.

2. An electrical operated vehicle deceleration warning device as claimed in claim 1 wherein the triggering means provides for a second activation to occur at a second and higher rate of deceleration threshold than that of the first threshold, the device providing that the consequential illumination mode of the hazard/indicator light(s) at the second threshold is for a second predetermined period and differs from the illumination mode provided at the first threshold.

3. An electrical operated vehicle deceleration warning device as claimed in claim 1 wherein the mode of illumination at the first threshold is substantially the same as the conventional illumination mode of the hazard/indicator lights.

4. An electrical operated vehicle deceleration warning device as claimed in claim 1, wherein the sensor is gravitationally sensitive and calibration means are included in the device enabling the sensor to be zeroed when mounted in situ.

5. An electrical operated vehicle deceleration warning device as claimed in claim 1 preceding claims wherein should the second activation occur during the first illumination period the illumination period thereafter will be the second illumination period.

6. An electrical operated vehicle deceleration warning device as claimed in claim 4 wherein the second threshold activation causes the hazard/indicator lights to flash at a rate noticeably higher than their conventional flashing rate.

7. An electrical operated vehicle deceleration warning device as claimed in claim 1 incorporated into a vehicle.

8. An electrical operated vehicle deceleration warning device as claimed in claim 2 wherein the mode of illumination at the first threshold is substantially the same as the conventional illumination mode of the hazard/indicator lights.

9. An electrical operated vehicle deceleration warning device as claimed in claim 2, wherein the sensor is gravitationally sensitive and calibration means are included in the device enabling the sensor to be zeroed when mounted in situ.

10. An electrical operated vehicle deceleration warning device as claimed in claim 3, wherein the sensor is gravitationally sensitive and calibration means are included in the device enabling the sensor to be zeroed when mounted in situ.

11. An electrical operated vehicle deceleration warning device as claimed in claim 5 wherein the second threshold activation causes the hazard/indicator lights to flash at a rate noticeably higher than their conventional flashing rate.
